(19) United States
(12) Patent Application Publication
(10) Pub. No.: US 2026/0121946 A1
(43) Pub. Date: Apr. 30, 2026

(54) VOICE QUALITY TESTING INCLUDING CODEC RATE CHANGE DETECTION

(71) Applicant: Boost SubscriberCo L.L.C., Englewood, CO (US)

(72) Inventor: Nikhil Rangaraajan Vijayakumar, Parker, CO (US)

(21) Appl. No.: 18/950,875

(22) Filed: Nov. 18, 2024

Related U.S. Application Data
(60) Provisional application No. 63/711,983, filed on Oct. 25, 2024.

(51) Int. Cl. H04L 41/5009; H04L 1/00; H04L 65/80; H04W 24/06

(52) U.S. Cl. CPC H04L 41/5009; H04L 1/0002; H04L 65/80; H04W 24/06

(57) ABSTRACT

A disclosed method may include (i) detecting a codec rate change during a voice quality test of a testing UE that emulates a subscriber UE connecting to a base station in a mobile network such that a test segment during which the codec rate change occurred is identified and (ii) reducing, based on detecting that the codec rate change occurred during the test segment, a weight of the test segment within a voice quality assessment.

### BRIEF SUMMARY

This disclosure is generally directed to systems, methods, and computer-readable media relating to voice quality testing. In some scenarios, traditional voice quality testing methods may encounter challenges when applied to modern mobile networks that utilize adaptive codec rates. These methods often assume a constant codec rate throughout a call, which may not accurately reflect the dynamic nature of contemporary network conditions. This discrepancy may potentially lead to inaccurate quality assessments, possibly masking real issues or creating false alarms about network performance. To address this problem, new testing methodologies may be developed that may account for codec rate changes during voice quality assessments. These methods might involve real-time detection of codec rate changes, potentially through analysis of Real-time Transport Protocol (RTP) payloads, monitoring of Medium Access Control (MAC) layer messages, or observation of vocoder settings. By identifying when codec rate changes occur, testing systems may be able to adjust their quality assessments accordingly, potentially providing a more accurate representation of voice quality under dynamic network conditions.

Another challenge that may arise in voice quality testing of adaptive codec systems is the potential for codec rate changes to occur during the transmission of standardized test sentences, such as Harvard sentences. These phonetically balanced sentences are often used to provide a consistent basis for voice quality assessment. However, when a codec rate change occurs mid-sentence, it may potentially distort the assessment results for that particular segment of the test. To mitigate this issue, some embodiments may adopt technique that involves segmenting voice quality tests into discrete units, such as individual sentences or phrases. When a codec rate change is detected, the affected segment might be excluded from the overall quality assessment. This technique may potentially prevent codec rate changes from disproportionately influencing the test results and may provide a more consistent basis for quality evaluation across varying network conditions.

In certain scenarios, the immediate aftermath of a codec rate change may introduce transient conditions that may affect voice quality measurements. These transient effects might not be representative of the steady-state quality at the new codec rate, potentially leading to skewed test results. To address this concern, some testing methodologies might incorporate a “guard time” after detecting a codec rate change. This guard time may allow the network and testing equipment to stabilize at the new codec rate before resuming quality measurements. Such technique may help to ensure that quality assessments are based on stable codec rate periods, potentially reducing the impact of transient conditions during rate changes and providing a more accurate reflection of the user experience under different network conditions.

The implementation of adaptive codec rates in mobile networks may introduce complexities in calculating Mean Opinion Score (MOS), a widely used metric for voice quality assessment. Traditional MOS calculations often assume consistent network conditions and codec rates throughout a call. However, in networks with adaptive codec rates, these assumptions may not hold, potentially leading to MOS values that do not accurately reflect the perceived quality of the entire call. To improve the accuracy of MOS calculations in adaptive codec environments, some solutions may involve developing more sophisticated algorithms that may account for codec rate changes. These algorithms might weight different segments of a call based on their respective codec rates, or they may calculate separate MOS values for each codec rate used during the call and combine them in a meaningful way. By adapting the MOS calculation method to the realities of modern networks, these techniques may potentially provide a more nuanced and accurate assessment of overall call quality.

Drive testing, a common method for assessing voice quality across different geographical areas, may face particular challenges in networks with adaptive codec rates. As a test vehicle moves through areas with varying signal strengths, the codec rate may change multiple times during a single test call. This dynamic environment may make it difficult to correlate voice quality issues with specific locations or network conditions using traditional drive testing methods. To enhance the effectiveness of drive testing in adaptive codec environments, some embodiments may incorporate real-time tracking of codec rate changes alongside GPS data. This technique may allow for more precise mapping of codec rates to specific locations, potentially enabling network operators to identify areas where network improvements may be needed to support higher codec rates. Additionally, analysis tools may be developed to visualize how codec rates change throughout a drive test route, providing insights into the relationship between network conditions, codec adaptation, and perceived voice quality.

The increased complexity introduced by adaptive codec rates may also pose challenges for network operators in identifying and diagnosing voice quality issues. Traditional troubleshooting methods that rely on static codec assumptions may not be effective in pinpointing the root causes of quality problems in adaptive systems. To address this, some solutions may involve developing more advanced analytics and troubleshooting tools that may correlate voice quality data with codec rate changes and other network parameters. These tools might employ machine learning algorithms to identify patterns and anomalies in the relationship between network conditions, codec rates, and voice quality metrics. By providing a more holistic view of the factors affecting voice quality, such tools may potentially enable network operators to more quickly and accurately diagnose and resolve issues, leading to improved overall network performance and user experience.

In some examples, a method includes (i) detecting a codec rate change during a voice quality test of a testing UE that emulates a subscriber UE connecting to a base station in a mobile network such that a test segment during which the codec rate change occurred is identified, (ii) reducing, based on detecting that the codec rate change occurred during the test segment, a weight of the test segment within a voice quality assessment, and (iii) performing, in response to the voice quality assessment indicating that a quality score is below a threshold, a remedial action such that voice quality for subscriber UEs connecting to the base station is improved.

In some examples, each test segment in a set of test segments used for the voice quality assessment comprises a sentence.

In some examples, each sentence comprises a Harvard sentence.

In some examples, detecting the codec rate change comprises analyzing Real-time Transport Protocol (RTP) payload information.

In some examples, detecting the codec rate change comprises detecting changes in a bit rate index in Medium Access Control (MAC) layer messages.

In some examples, detecting the codec rate change comprises monitoring vocoder settings of the testing UE.

In some examples, the voice quality assessment comprises calculating a Mean Opinion Score (MOS).

In some examples, the remedial action comprises adjusting transmission power of the base station.

In some examples, the remedial action comprises adjusting antenna tilt of the base station.

In some examples, the method further comprises adjusting an algorithm used to calculate the quality score based on the detected codec rate change.

In some examples, the voice quality test is performed on both originating and terminating ends of a test call.

In some examples, a guard time is implemented after detecting the codec rate change, the guard time is satisfied when the codec rate remains stable for a predetermined duration, and the affected test segment is excluded only after the guard time is satisfied.

In some examples, the codec rate change is detected based on a mapping table between a bit rate index and corresponding codec rates.

In some examples, reducing the weight of the test segment comprises excluding the test segment from being used by the voice quality assessment.

In some examples, the testing UE is connected to an interface device that simulates audio input and output and the interface device is connected to a laptop running a testing tool that controls test call setup and voice quality assessment.

In some examples, the voice quality test is performed during a drive test to assess network performance across different geographic locations.

In some examples, a non-transitory computer-readable medium has instructions stored thereon that, when executed by at least one physical computing processor, cause a computing device to perform operations comprising (i) detecting a codec rate change during a voice quality test of a testing UE that emulates a subscriber UE connecting to a base station in a mobile network such that a test segment during which the codec rate change occurred is identified, (ii) reducing, based on detecting that the codec rate change occurred during the test segment, a weight of the test segment within a voice quality assessment, and (iii) performing, in response to the voice quality assessment indicating that a quality score is below a threshold, a remedial action such that voice quality for subscriber UEs connecting to the base station is improved.

In some examples, a system comprises at least one physical computing processor of a computing device and a non-transitory computer-readable medium that has instructions stored thereon that, when executed by the at least one physical computing processor, cause the computing device to perform operations comprising (i) detecting a codec rate change during a voice quality test of a testing UE that emulates a subscriber UE connecting to a base station in a mobile network such that a test segment during which the codec rate change occurred is identified, (ii) reducing, based on detecting that the codec rate change occurred during the test segment, a weight of the test segment within a voice quality assessment, and (iii) performing, in response to the voice quality assessment indicating that a quality score is below a threshold, a remedial action such that voice quality for subscriber UEs connecting to the base station is improved.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to voice quality testing.

FIG. 2 illustrates an example multi-panel diagram depicting the process of voice quality testing and codec rate adaptation in a mobile network environment.

FIG. 3 shows an example detailed illustration focusing on the technical aspects of codec rate detection and voice quality assessment.

FIG. 4 illustrates an example detailed view of the testing setup, focusing on the interface device that connects the testing UE to the testing tool.

FIG. 5 depicts a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,”“an,”and “the”include singular and plural references.

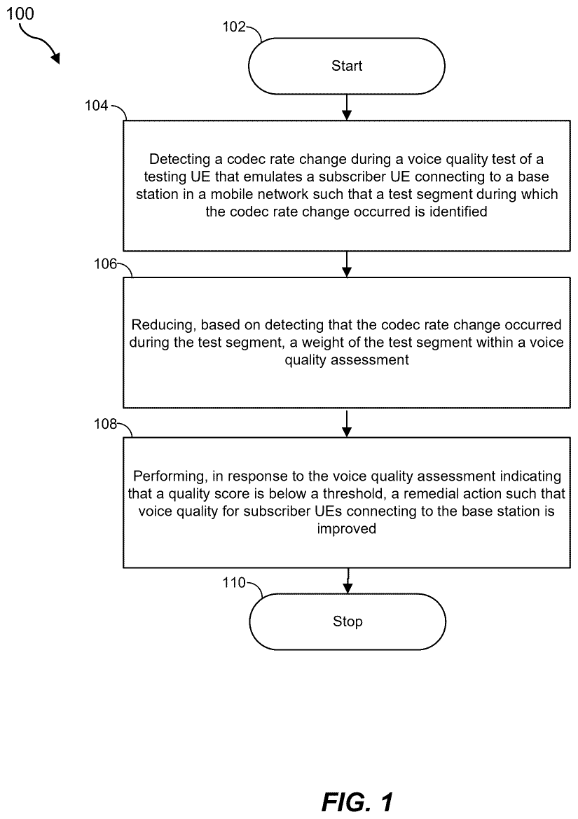

FIG. 1 shows a flow diagram for a method 100 relating to cellular coverage acquisition. At step 102, method 100 may start. At step 104, method 100 includes detecting a codec rate change during a voice quality test of a testing UE that emulates a subscriber UE connecting to a base station in a mobile network such that a test segment during which the codec rate change occurred is identified. As used herein, a segment may be affected if it is different than it would have been without the codec change. At step 106, method 100 includes reducing, based on detecting that the codec rate change occurred during the test segment, a weight of the test segment within a voice quality assessment. At step 108, method 100 includes performing, in response to the voice quality assessment indicating that a quality score is below a threshold, a remedial action such that voice quality for subscriber UEs connecting to the base station is improved. At step 110, method 100 may end.

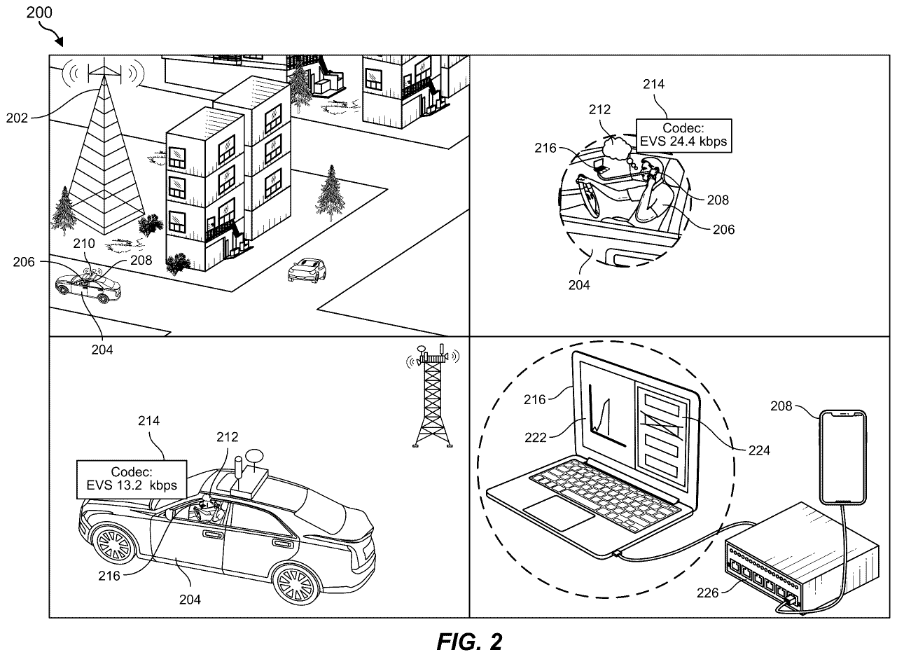

In the top-left panel of FIG. 2, a cityscape may be shown, which may represent an urban environment where mobile network testing may frequently take place. Within this setting, a cell tower 202 may be prominently featured in the foreground. This cell tower 202 may, in some scenarios, represent a base station in the mobile network, serving as a helpful component in the communication infrastructure. On a street within this urban landscape, a car 204 may be depicted, which may be used to simulate movement through different network coverage areas during testing. Inside the car 204, a person 206 may be shown, who might represent a technician or tester conducting the voice quality assessment. The person 206 may be holding a smartphone 208, which, in some embodiments, may serve as the testing UE that emulates a subscriber device. Above the car 204, a signal indicator 210 with multiple bars may be visible. This indicator 210 may potentially represent the network connection strength, providing a visual cue about the current signal conditions. In this initial scenario depicted in the top-left panel, the signal indicator 210 may show full bars, which may suggest a strong connection to the cell tower 202, simulating optimal network conditions that might be encountered during testing.

The top-right panel of FIG. 2 may provide a more detailed view of the testing setup within the car 204. In this panel, the person 206 may be shown holding the smartphone 208 to their ear, which may simulate engagement in a test call. A speech bubble 212 may be depicted emanating from their mouth, containing a waveform pattern. This waveform pattern might represent the voice data being transmitted during the test call, providing a visual representation of the audio being assessed. Above the smartphone 208, a small text box 214 may be visible. This text box 214 may be labeled “Codec: EVS 24.4 kbps” in some examples, potentially indicating the current codec rate being used for the voice transmission. The inclusion of this detail may illustrate how the testing system might monitor and display real-time codec information during the assessment process. As further shown in FIG. 2, adjacent to the person 206, a laptop 216 may be shown connected to the smartphone 208 via a cable. This laptop 216 might represent the testing equipment used in the voice quality assessment process, potentially running specialized software for data collection and analysis.

In the bottom-left panel of FIG. 2, a scene similar to the top-right panel may be presented, but with some differences that may illustrate changing network conditions. The car 204 is depicted further away from the cell tower 202, which simulates movement to an area with weaker signal strength. In response to changing conditions, the text box 214 is updated to read “Codec: EVS 13.2 kbps”. This change indicates a codec rate adaptation in response to the worsening signal strength, demonstrating how the network may adjust transmission parameters to maintain call quality in challenging conditions.

The bottom-right panel of FIG. 2 focuses on a laptop screen, potentially providing insight into the data collection and analysis aspects of the voice quality testing process. The screen may be divided into two sections, each displaying different types of information that might be relevant to the assessment. On the left side of the screen, a graph 222 may be shown with a line that exhibits a sudden drop. This graph 222 may represent real-time voice quality scores, with the drop potentially correlating to the codec rate change observed in the previous panel. The visualization of this data might allow testers to quickly identify potential issues or anomalies during the testing process. On the right side of the screen, a list of test segments 224 may be visible. In some embodiments, these segments might correspond to individual sentences or phrases used in the voice quality assessment. One of these segments is highlighted and crossed out, which may indicate the removal or reduced weighting of a test segment during which the codec rate change occurred. This visual representation might illustrate how the testing system may adapt its assessment methodology in response to detected codec rate changes. Below the laptop, an interface device 226 with multiple ports may be shown, connecting the smartphone 208 to the laptop 216. This interface device 226 might serve as a helpful link between the testing UE and the analysis equipment, potentially facilitating the transfer of data and control signals necessary for comprehensive voice quality assessment.

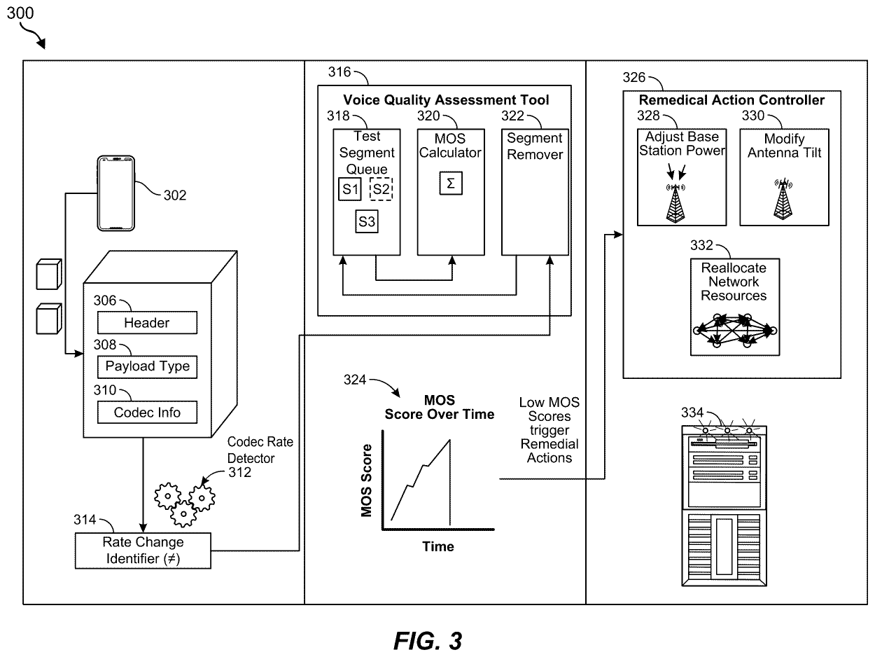

FIG. 3 shows a detailed illustration focusing on the technical aspects of codec rate detection and voice quality assessment in a mobile network environment. The figure is divided into three vertical panels of equal width, each depicting different components and processes involved in the voice quality testing methodology. This comprehensive diagram may provide insights into the complex interplay between data transmission, codec rate detection, quality assessment, and network optimization that may occur during voice quality testing in modern mobile networks.

The left panel of FIG. 3 presents a simplified representation of the data flow and initial processing stages that may occur during a voice quality test. At the top of this panel, a smartphone 302 is shown, which may represent the testing UE used in the voice quality assessment process. In some embodiments, this testing UE might emulate a subscriber device, enabling realistic simulation of user experiences. Below the smartphone 302, a series of rectangles representing data packets are depicted flowing downward, simulating the stream of voice data during a test call. These packets may correspond to Real-time Transport Protocol or RTP packets, as discussed further below. These packets may be commonly used for voice transmission in IP-based networks. Inside this RTP packet, smaller sections are visible, labeled “Header” 306, “Payload Type” 308, and “Codec Info” 310. These sections may represent key components of an RTP packet that may be analyzed during the codec rate detection process. In some scenarios, the “Payload Type” 308 and “Codec Info” 310 sections may be particularly relevant for determining the current codec rate being used. The detailed representation of these packet components might underscore the granular level at which voice data may be analyzed in sophisticated testing systems, potentially enabling highly accurate and responsive codec rate detection.

From the “Payload Type” 308 and “Codec Info” 310 sections, arrows point to a section below labeled “Codec Rate Detector” 312. This section 312 contains gears or circuitry patterns, which may visually represent its processing function. The Codec Rate Detector 312 might analyze the information from the RTP packets to determine the current codec rate being used for voice transmission. In some embodiments, this component may play a role in identifying when codec rate changes occur during a voice quality test. The detection process might involve complex algorithms that compare packet information against known codec specifications, potentially enabling real-time identification of codec rates even in dynamic network environments. Below the Codec Rate Detector 312, an arrow points to a box labeled “Rate Change Identifier” 314. This box 314 contains a comparison symbol (≠), which may indicate its function of identifying changes in the codec rate. The Rate Change Identifier 314 might compare the current codec rate with previous rates to detect any changes that occur during the test. In some scenarios, this component may trigger adjustments in the voice quality assessment process when a codec rate change is detected. The separation of detection and identification functions into distinct components, as shown in this figure, might suggest a modular technique to codec rate analysis, potentially enabling greater flexibility and precision in the testing process.

The center panel of FIG. 3 focuses on the Voice Quality Assessment Tool 316, represented by a large rectangular box. This panel may illustrate the example components and processes involved in evaluating voice quality based on the collected data and detected codec rates. Inside the Voice Quality Assessment Tool 316, three sections are visible, each representing a different aspect of the assessment process. The first section, labeled “Test Segment Queue” 318, shows a series of small rectangles representing test segments, labeled S1, S2, S3, and so on. These segments may correspond to individual sentences or phrases used in the voice quality test, such as Harvard sentences. In some embodiments, this queue might be dynamically updated based on detected codec rate changes, enabling the assessment tool to adapt its testing methodology in real-time. The visual representation of this queue might suggest a sequential processing technique, where each segment is evaluated individually, potentially enabling fine-grained analysis of voice quality throughout the duration of a test call. Below the Test Segment Queue 318, a box labeled “MOS Calculator” 320 is shown. This box contains a sigma (Σ) symbol, which may represent the calculation of the Mean Opinion Score (MOS), a metric for voice quality assessment. The MOS Calculator 320 might process the test segments to produce a numerical score indicating the perceived quality of the voice transmission. In some scenarios, this calculation may involve complex algorithms that take into account various factors such as audio clarity, latency, and the effects of codec rate changes. The third section within the Voice Quality Assessment Tool 316 is labeled “Segment Remover” 322. In some embodiments, the Segment Remover 322 may be responsible for excluding or reducing the weight of test segments affected by codec rate changes, potentially helping to maintain the accuracy of the voice quality assessment. This feature might be particularly important in scenarios where sudden codec rate changes may otherwise skew the overall quality assessment.

An arrow is shown connecting the Rate Change Identifier 314 from the left panel to the Segment Remover 322 in the center panel. This connection may indicate that when a codec rate change is detected, the information is passed to the Voice Quality Assessment Tool 316, potentially triggering the removal or re-weighting of affected test segments. From the Segment Remover 322, an arrow points to the Test Segment Queue 318, showing a dotted outline around one of the segments. This visual cue may represent the potential removal or re-weighting of a segment in response to a detected codec rate change. Another arrow connects the Test Segment Queue 318 to the MOS Calculator 320, indicating the flow of test segments for quality assessment. This interconnected system of components might allow for a highly responsive and adaptive assessment process, capable of adjusting to changing network conditions in real-time. At the bottom of the center panel, a graph 324 is depicted, showing MOS score over time. The y-axis is labeled “MOS Score” and the x-axis is labeled “Time”. A line on this graph shows a sudden drop, which may correspond to a codec rate change. This graph 324 might provide a visual representation of how codec rate changes may impact the perceived voice quality during a test, potentially enabling testers to quickly identify and investigate quality fluctuations.

The right panel of FIG. 3 illustrates potential remedial actions that might be taken in response to detected voice quality issues, showcasing how the testing process may potentially lead to concrete network improvements. At the top of this panel, a box labeled “Remedial Action Controller” 326 is shown. This component may be responsible for initiating various actions to improve voice quality when issues are detected. In some embodiments, the Remedial Action Controller 326 might employ sophisticated decision-making algorithms to determine the most appropriate course of action based on the nature and severity of detected quality issues. Below the Remedial Action Controller 326, three sub-boxes represent different types of remedial actions. The first box, labeled “Adjust Base Station Power” 328, shows a transmitter tower icon with arrows indicating power adjustment. This may represent one possible action to improve signal strength and, consequently, voice quality. The second sub-box, labeled “Modify Antenna Tilt” 330, depicts a tilting antenna with angle markings. This illustration may suggest another potential method for optimizing network coverage and improving voice quality in specific areas. The third sub-box, labeled “Reallocate Network Resources” 332, shows interconnected nodes and arrows. This representation might indicate actions related to load balancing or resource redistribution within the network to enhance voice quality. The inclusion of these varied remedial actions in the figure may underscore the multifaceted technique that modern networks may take to address voice quality issues, potentially enabling highly targeted and effective optimizations.

An arrow connects the MOS graph 324 in the center panel to the Remedial Action Controller 326, suggesting that low MOS scores might trigger remedial actions. This connection may illustrate how the voice quality assessment process may directly inform and initiate network optimization efforts, potentially creating a feedback loop that continuously improves network performance. At the bottom of the right panel, a simplified base station 334 is depicted with visual indicators such as signal waves or LEDs. These indicators may show the effects of the remedial actions, potentially representing improvements in network performance and voice quality. The inclusion of this base station representation might serve to ground the abstract concepts of network optimization in a tangible, real-world context, emphasizing the practical outcomes of the voice quality testing and improvement process.

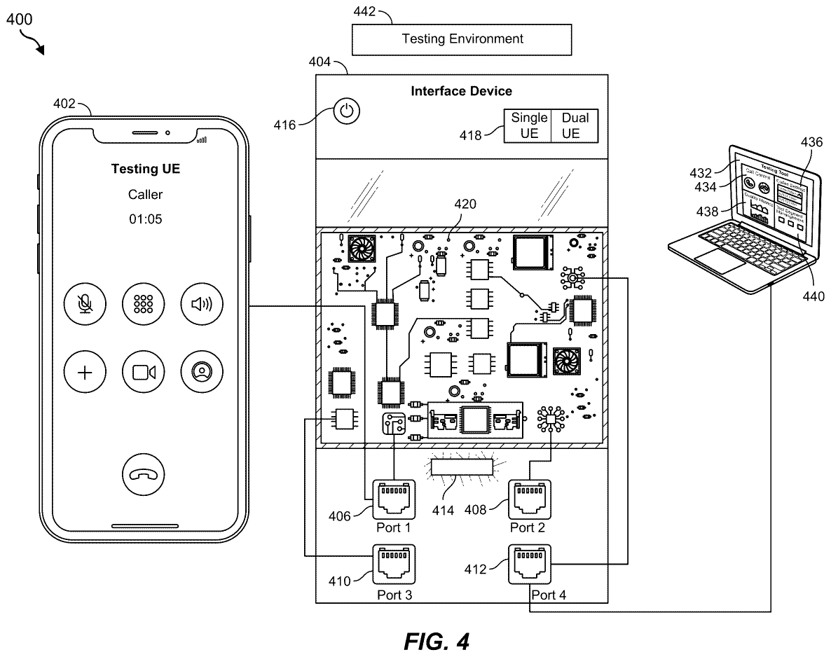

FIG. 4 illustrates a detailed view of the testing setup, focusing on the interface device that connects the testing UE to the testing tool. This figure presents a single panel with a cutaway view to show both external and internal components of the testing apparatus, providing a comprehensive look at the hardware involved in voice quality assessment in mobile networks. On the left side of FIG. 4, a detailed smartphone representing the testing UE 402 is shown. The device is depicted with a large touchscreen, characteristic of modern smartphones. On the screen of the testing UE 402, a simple interface is visible, showing a call in progress. This interface includes a timer and a signal strength indicator, which may be used to simulate real-world calling conditions during the voice quality test. In some scenarios, this testing UE 402 may emulate a subscriber device, enabling accurate replication of user experiences in various network conditions.

To the right of the smartphone, a rectangular device labeled “Interface Device” 404 is depicted. On the front face of the interface device 404, four ports are visible, labeled “Port 1” 406, “Port 2” 408, “Port 3” 410, and “Port 4” 412. Each of these ports resembles a standard USB or Ethernet port, which may suggest the device's compatibility with various connection types. In some embodiments, these multiple ports might allow for simultaneous testing of multiple devices or for connecting additional testing equipment. Above the ports on the interface device 404, small LED indicators 414 are shown. These LEDs may serve to display power and activity status, potentially providing visual cues about the device's operation during testing. On the top of the interface device 404, a power button 416 and a mode switch 418 are visible. The mode switch 418 is shown with positions labeled “Single UE” and “Dual UE”. This switch may allow the testing setup to be configured for different testing scenarios, such as testing a single device or simulating a two-way call between devices. The presence of these various external features on the interface device 404 might indicate its versatility and adaptability to different testing requirements, potentially enabling a wide range of voice quality testing scenarios to be explored using a single piece of equipment.

To the right of the interface device 404, a laptop representing the testing tool 432 is shown. The laptop 432 is depicted in an open position with its screen visible, suggesting active use during the testing process. On the screen of the laptop 432, a user interface is displayed, divided into four sections. These sections provide a glimpse into the software side of the voice quality testing system. The first section on the laptop screen is labeled “Call Control” 434. This section shows buttons for initiating and ending calls, which may allow testers to precisely control the timing and duration of test calls. The second section, labeled “Codec Settings” 436, displays a dropdown menu with various codec options, such as EVS 24.4 kbps and EVS 13.2 kbps. This feature might enable testers to manually select or verify the codec rates being used during tests, providing an additional layer of control over the testing parameters. The third section of the laptop interface is titled “Quality Metrics” 438 and shows a real-time graph of MOS scores. This graph may provide immediate visual feedback on voice quality throughout the duration of a test call, enabling testers to quickly identify any fluctuations or issues. The fourth section, labeled “Test Segment Management” 440, illustrates a list of test segments with checkboxes. This interface might allow testers to manually include or exclude specific test segments from the voice quality assessment, providing flexibility in how test data is analyzed. The comprehensive nature of this software interface may indicate the level of control and analysis capabilities that might be available in sophisticated voice quality testing systems, potentially enabling highly detailed and customizable testing procedures.

Cables are shown connecting the smartphone 402 to Port 1 406 of the interface device 404, and another cable connects the interface device 404 to the laptop 432 via Port 4 412. These connections illustrate the physical setup of the testing apparatus, showing how data might flow from the testing UE through the interface device to the analysis software on the laptop. Above the entire setup, a text box 442 labeled “Testing Environment” provides context for the illustration. This label may serve to remind viewers that the depicted setup represents a controlled testing scenario rather than a typical user environment. In some embodiments, the comprehensive setup shown in FIG. 4 may allow for highly detailed and controlled voice quality testing. The combination of specialized hardware in the interface device 404 and sophisticated software on the testing tool 432 might enable testers to simulate a wide range of network conditions and codec scenarios. This setup may potentially provide valuable insights into voice quality under various circumstances, helping to identify areas for improvement in mobile network performance and user experience. The level of detail and sophistication shown in this testing setup may underscore the complexity of modern voice quality assessment in mobile networks, highlighting the potential need for specialized equipment and software to accurately evaluate and optimize voice communication quality in increasingly complex and dynamic network environments.

In some examples, each test segment in a set of test segments used for the voice quality assessment may comprise a sentence. The use of sentences as test segments may provide a standardized and repeatable method for assessing voice quality. These sentences may vary in length, complexity, and phonetic content to thoroughly test different aspects of voice transmission. In some embodiments, the sentences might be crafted to include a wide range of phonemes and prosodic features present in the language being tested. For instance, the sentences may incorporate various consonant clusters, vowel sounds, and intonation patterns to assess how well the voice codec handles different speech elements. The duration of these sentence-based test segments may range from a few seconds to around 10 seconds, enabling a balance between granularity in testing and overall test efficiency. In certain scenarios, the sentences might be recorded by professional voice actors to ensure clarity and consistency across multiple tests. Alternatively, synthetic speech generation techniques may be employed to create standardized test sentences with precisely controlled acoustic properties. The content of these sentences may be designed to be neutral and universally understandable, avoiding culturally specific references or complex terminology that might influence listener perception. In some cases, the sentences might be semantically unpredictable to prevent testers from becoming overly familiar with the content and potentially biasing their quality assessments. The use of sentence-based test segments may allow for easy comparison between different network conditions, codec rates, or device types, as the same set of sentences may be consistently used across various testing scenarios. Additionally, sentence-based segments might facilitate the calculation of specific metrics such as speech intelligibility or listening effort, which may complement overall quality scores like MOS. Some testing methodologies might employ a mix of different sentence types within a single test, such as declarative statements, questions, and exclamations, to assess how well the voice transmission system handles various speech patterns and intonations. In more advanced testing scenarios, the selection of sentences might be dynamically adjusted based on detected network conditions or codec changes, ensuring that the most relevant test content is used for each specific testing situation.

In some examples, each sentence may comprise a Harvard sentence. Harvard sentences, also known as IEEE sentences, are a set of phonetically balanced sentences that were originally developed at Harvard University for use in audio testing and telecommunications research. These sentences are designed to provide a comprehensive representation of the phonemes and phonetic combinations found in the English language, making them particularly useful for voice quality assessment in various scenarios. The use of Harvard sentences in voice quality testing may offer several advantages and may be implemented in various ways to suit different testing requirements.

Harvard sentences may consist of short, semantically unpredictable statements that contain a mix of commonly used words. For instance, one such sentence might be “The birch canoe slid on the smooth planks.” These sentences are crafted to include a distribution of phonemes that closely matches the frequency of occurrence in conversational English. This phonetic balance may help ensure that voice quality tests cover a wide range of speech sounds and transitions, potentially providing a more comprehensive assessment of codec performance across different phonetic contexts.

In some embodiments, a standard set of Harvard sentences might be used across all voice quality tests to ensure consistency and comparability between different testing sessions or network conditions. Alternatively, testing systems might employ a larger pool of Harvard sentences and randomly select a subset for each test, balancing consistency with variety to prevent testers from becoming overly familiar with the content. The number of sentences used in a single test may vary depending on the specific testing methodology and time constraints. Some systems might use as few as 10 sentences for a quick assessment, while others might employ 50 or more sentences for a more thorough evaluation.

The presentation of Harvard sentences during voice quality testing may be implemented in various ways. In some scenarios, the sentences might be pre-recorded by professional voice actors to ensure clear and consistent delivery. These recordings may be played back through the testing UE, simulating a real voice call. In other embodiments, text-to-speech technology might be used to generate the sentences in real-time, potentially enabling greater flexibility in testing different voice characteristics or accents. Some advanced testing systems might even use a combination of pre-recorded and synthesized speech to evaluate how well voice codecs handle different types of audio input.

While Harvard sentences were originally developed for English language testing, the concept has been adapted or updated for other languages as well. Similar phonetically balanced sentence sets, which may also be referred to as Harvard sentences, have been created for languages such as Mandarin, Spanish, and French, among others. This enables comprehensive voice quality testing across different linguistic contexts, which may be particularly valuable for assessing the performance of voice codecs in multilingual or international network environments.

In some examples, detecting the codec rate change may comprise analyzing Real-time Transport Protocol (RTP) payload information. This analysis of RTP payload information may provide a robust and efficient method for identifying changes in codec rates during voice quality testing. RTP is widely used for delivering audio and video over IP networks, making it a valuable source of information for voice quality assessment. The payload of an RTP packet typically contains the encoded media data along with additional metadata that may indicate the codec type and parameters being used. In some embodiments, the analysis process might involve examining the payload type field in the RTP header, which may provide a quick indication of the codec in use. However, for more detailed codec rate information, deeper inspection of the payload itself may be necessary or helpful. This may involve parsing the payload according to the specific encoding format being used, such as Adaptive Multi-Rate (AMR) or Enhanced Voice Services (EVS) for mobile networks. In the case of EVS, for example, the payload might contain information about the bit-rate mode being used, which may directly indicate the codec rate.

The process of analyzing RTP payload information might be implemented in various ways depending on the testing setup and requirements. In some scenarios, a dedicated hardware device might perform real-time analysis of RTP packets as they flow between the testing UE and the network. Alternatively, software-based solutions running on a general-purpose computer may capture and analyze RTP traffic, potentially offering more flexibility in terms of updating analysis algorithms. Machine learning techniques might also be employed to detect patterns in RTP payload data that indicate codec rate changes, potentially enabling more nuanced detection in complex or novel codec embodiments.

The frequency of RTP payload analysis may vary depending on the testing requirements. In some embodiments, every RTP packet might be analyzed to provide the most granular detection of codec rate changes. In other cases, periodic sampling of RTP packets might be sufficient, balancing detection accuracy with computational efficiency. The analysis process might also involve maintaining a history of recent codec rate information to detect changes over time, rather than relying solely on instantaneous measurements.

In more sophisticated embodiments, the RTP payload analysis might not only detect codec rate changes but also extract additional information that may be valuable for voice quality assessment. This may include details about packet loss concealment techniques being used, comfort noise generation parameters, or even information about the audio content itself that might influence perceived quality. By leveraging the rich information available in RTP payloads, voice quality testing systems may potentially provide more comprehensive and context-aware assessments of call quality in various network conditions.

In some examples, detecting the codec rate change may comprise detecting changes in a bit rate index in Medium Access Control (MAC) layer messages. This technique leverages the lower layers of the network protocol stack to identify codec rate changes, potentially offering a more direct and responsive method of detection compared to analyzing higher-layer data. The MAC layer plays a role in managing access to the shared wireless medium in mobile networks, and as such, it may contain valuable information about the current state of the connection, including the codec rate being used for voice transmission.

The bit rate index in MAC layer messages typically represents a standardized set of values that correspond to specific codec rates. For instance, in some embodiments, a bit rate index of 0 might correspond to the lowest supported codec rate, while higher index values represent progressively higher codec rates. The exact mapping between bit rate indices and codec rates may vary depending on the specific network technology and codec family being used. In 4G LTE networks, for example, the bit rate index might correspond to different Adaptive Multi-Rate (AMR) codec modes, while in 5G networks, it may represent various modes of the Enhanced Voice Services (EVS) codec.

Detecting changes in the bit rate index may be implemented in various ways, depending on the testing setup and available access to network information. In some scenarios, specialized testing equipment might be used to directly monitor MAC layer messages exchanged between the user equipment (UE) and the base station. This may involve passive monitoring of the air interface, capturing and decoding MAC layer frames in real-time. Alternatively, if the testing is conducted with cooperation from the network operator, the detection might be performed by accessing internal network elements that have visibility into MAC layer communications.

The frequency of checking for bit rate index changes may vary based on the specific testing requirements and network characteristics. In some embodiments, the bit rate index might be monitored continuously, enabling near-instantaneous detection of codec rate changes. In other cases, periodic checking at regular intervals (e.g., every 100 milliseconds) might be sufficient to capture relevant changes while minimizing computational overhead. Additionally, some systems might employ event-driven checking, where the bit rate index is only examined when certain network conditions or performance metrics indicate that a codec rate change is likely to have occurred.

Advanced embodiments might not only detect changes in the bit rate index but also analyze the patterns and timing of these changes. This may provide valuable insights into how the network adapts codec rates in response to changing conditions. For example, the system might track how quickly the network responds to deteriorating signal conditions by lowering the codec rate, or how aggressively it increases the rate when conditions improve. This information may be used to evaluate the effectiveness of the network's rate adaptation algorithms and potentially identify areas for optimization.

In some scenarios, the detection of bit rate index changes in MAC layer messages might be combined with other detection methods, such as analyzing RTP payload information or monitoring vocoder settings. This multi-layered technique may provide a more robust and comprehensive detection system, potentially capable of identifying codec rate changes even in complex or non-standard network configurations.

The process of detecting changes in the bit rate index might also involve maintaining a history of recent values to identify trends or patterns. This historical data may be used to filter out transient fluctuations and focus on sustained changes in codec rate, which are more likely to have a significant impact on voice quality. Additionally, machine learning techniques may potentially be employed to predict upcoming codec rate changes based on observed patterns in the bit rate index and other network parameters, enabling proactive adjustments in voice quality testing methodologies. By leveraging the information available in MAC layer messages, voice quality testing systems may potentially achieve highly responsive and accurate detection of codec rate changes, enabling more precise and context-aware assessments of voice quality in dynamic mobile network environments.

In some examples, detecting the codec rate change may comprise monitoring vocoder settings of the testing UE. This technique focuses on directly observing the behavior of the voice encoder/decoder (vocoder) within the testing device, potentially offering a highly accurate and device-specific method of detecting codec rate changes. Vocoders play a role in mobile voice communication, compressing speech signals for efficient transmission over the network and then reconstructing them on the receiving end. By monitoring the vocoder settings, testing systems may be able to detect codec rate changes as they occur within the device itself, regardless of how these changes are signaled at the network level. The process of monitoring vocoder settings may be implemented in various ways, depending on the specific testing setup and the level of access available to the device's internal components. In some scenarios, this monitoring might be achieved through specialized testing firmware installed on the UE, which provides direct access to vocoder parameters. Alternatively, monitoring vocoder settings might be accomplished through APIs provided by the device's operating system or chipset manufacturer. These APIs may expose relevant vocoder parameters to testing applications, enabling programmatic monitoring of codec rates. The specific parameters monitored may vary depending on the codec in use. For example, in an Adaptive Multi-Rate (AMR) codec, the system might monitor the active codec mode, which directly corresponds to the bit rate. In more advanced codecs like Enhanced Voice Services (EVS), additional parameters such as bandwidth mode (narrowband, wideband, super-wideband) and bit rate might be monitored simultaneously to get a complete picture of the current codec configuration.

The frequency of monitoring vocoder settings may be adjusted based on testing requirements and device capabilities, ranging from continuous monitoring to periodic checking at regular intervals. Advanced embodiments might not only detect changes in vocoder settings but also analyze the patterns and timing of these changes, providing insights into how the device and network interact to adapt voice encoding in response to changing conditions. In some scenarios, vocoder setting monitoring might be combined with other detection methods, such as analyzing RTP payload information or MAC layer messages, to provide a more comprehensive view of codec rate changes. The monitoring process might also involve maintaining a history of recent vocoder settings to identify trends or patterns, potentially using machine learning techniques to predict upcoming codec rate changes. For testing setups that involve multiple devices or simulated network endpoints, monitoring vocoder settings may be performed on both the transmitting and receiving ends of the call, providing insights into how codec rate changes propagate through the network and affect voice quality in both directions of a conversation. In more sophisticated embodiments, the vocoder setting monitoring might be integrated with voice quality assessment algorithms, enabling real-time adjustment of quality metrics based on the current codec configuration. This integration may enable more accurate and context-aware assessments of voice quality, accounting for the specific behavior of different device models and vocoder embodiments in dynamic mobile network environments.

The RTP payload analysis, MAC layer message monitoring, and vocoder setting observation techniques to detecting codec rate changes each offer distinct advantages and challenges, while also sharing some overlapping characteristics. RTP payload analysis operates at the application layer, providing direct access to the encoded voice data and associated codec information. This method may offer high accuracy in determining the exact codec rate being used, as the information is directly embedded in the voice packets. However, it may introduce some latency in detection, as the analysis occurs after the packets have been fully formed and transmitted. Additionally, RTP analysis might require more computational resources, especially in high-bandwidth scenarios with numerous voice calls being monitored simultaneously. The MAC layer technique, operating at a lower level of the network stack, may offer faster detection of codec rate changes, as it may potentially intercept network instructions before they are fully processed by the device. This method might be particularly effective in scenarios where network conditions are rapidly changing, enabling near real-time adaptation of voice quality testing parameters. However, MAC layer monitoring may require specialized equipment or network access, potentially limiting its applicability in some testing environments. The vocoder setting monitoring technique offers the advantage of direct observation of the device's behavior, potentially capturing codec rate changes that might not be immediately reflected in network traffic. This method may be particularly valuable for detecting device-specific behaviors or discrepancies between network instructions and actual codec implementation. However, it may require deeper integration with the device's software or firmware, potentially limiting its portability across different device models or operating systems.

In terms of their interrelationships, these methods may be visualized as overlapping circles in a Venn diagram. The central area where all three circles intersect represents scenarios where a codec rate change is simultaneously reflected in RTP packets, MAC layer messages, and vocoder settings. This overlap might occur in ideal conditions with modern, fully compliant devices and networks. The areas where only two circles overlap may represent scenarios with partial information or delayed propagation of codec rate changes. For instance, a change might be detected in MAC layer messages and vocoder settings before it appears in RTP packets, or a discrepancy might be observed between network instructions (MAC layer) and actual device behavior (vocoder settings). The non-overlapping areas of each circle may represent unique information or capabilities provided by each method, such as the ability of RTP analysis to examine packet loss patterns, MAC layer monitoring to observe other network parameters, or vocoder setting observation to detect device-specific optimizations.

Given these characteristics, using a combination of two or all three methods may provide a more comprehensive and robust technique to codec rate change detection. Such a multifaceted technique might be particularly valuable in complex testing scenarios or when developing new voice quality assessment methodologies. For instance, using all three methods simultaneously may allow for cross-validation of detected changes, potentially identifying discrepancies or delays in codec rate adaptation across different layers of the communication stack. However, the choice of method(s) would likely depend on specific testing requirements, available resources, and the particular network and device ecosystem being evaluated. In general, the MAC layer technique might be considered the most popular or widely applicable, as it offers a good balance between detection speed and implementation complexity. However, each method faces its own set of challenges. RTP analysis may contend with the potential for encrypted payloads in secure communications. MAC layer monitoring may struggle with proprietary or non-standard network embodiments. Vocoder setting observation might face challenges with closed or restricted device architectures. Ultimately, the best method would depend on the specific testing context, with factors such as required detection speed, available network/device access, computational resources, and the need for cross-layer validation all playing a role in the selection process.

In some examples, the voice quality assessment may comprise calculating a Mean Opinion Score (MOS). The Mean Opinion Score is a metric for evaluating the perceived quality of voice communications. Modern voice quality testing often employs objective computational methods to estimate MOS values. These computational techniques may aim to predict how an average listener would rate the quality of a voice transmission on a scale typically ranging from 1 (poor) to 5 (excellent). The calculation of MOS in voice quality assessments may be implemented through various algorithms and methodologies, each with its own strengths and considerations. One common technique to calculating MOS involves the use of perceptual evaluation of speech quality (PESQ) algorithms. PESQ compares the original, undistorted speech signal with the degraded signal received after transmission through the network. This comparison may take into account various factors such as signal distortion, background noise, and packet loss. The PESQ algorithm may analyze the signals in the frequency domain, applying psychoacoustic principles to weight different aspects of the audio based on their perceptual importance to human listeners. More advanced versions of PESQ, such as POLQA (Perceptual Objective Listening Quality Assessment), may offer improved accuracy and the ability to assess super-wideband audio, which is becoming increasingly common in modern voice codecs. Another method for calculating MOS may involve the use of E-model calculations, which are particularly relevant for IP-based voice communications. The E-model takes into account various impairment factors such as network delay, packet loss, and codec characteristics to estimate the overall quality of the voice transmission. This model may be especially useful in scenarios where access to the original, undistorted speech signal is not available, as it may operate solely on network and codec parameters. Some embodiments might combine aspects of PESQ and E-model calculations to provide a more comprehensive quality assessment.

In scenarios where codec rate changes are a significant factor, the MOS calculation process may need to be adapted to account for these dynamic conditions. For instance, the assessment system might calculate separate MOS values for different codec rate segments within a single call, potentially using different evaluation criteria or weighting factors based on the specific codec rate in use. These segment-specific scores may then be combined using various methods, such as time-weighted averaging or more complex statistical techniques, to produce an overall MOS for the entire call. Some advanced MOS calculation methods may incorporate machine learning techniques. These techniques might use neural networks or other AI models trained on large datasets of human-rated voice samples to predict MOS values. Such models may potentially account for a wide range of factors affecting voice quality, including codec rate changes, network conditions, and even contextual factors like the type of content being transmitted. Machine learning-based MOS calculations might offer the advantage of adapting to new codec technologies or network conditions more easily than traditional algorithmic techniques. The temporal resolution of MOS calculations may vary depending on the specific testing requirements. Some systems might calculate MOS values for each individual test segment (e.g., each sentence in a set of test phrases), while others might produce scores at regular time intervals (e.g., every 5 seconds) or for entire calls. Higher temporal resolution may provide more detailed insights into how voice quality varies over time, potentially at the cost of increased computational complexity. In multi-endpoint testing scenarios, such as simulated conference calls, the MOS calculation process might need to account for the quality of multiple simultaneous voice streams. This may involve calculating individual MOS values for each participant and then combining them in a way that reflects the overall perceived quality of the multi-party conversation. Factors such as speaker identification, talk-over detection, and the balance of audio levels between participants might all play a role in these more complex MOS calculations. By employing sophisticated MOS calculation methods that may adapt to dynamic codec rates and diverse network conditions, voice quality assessment systems may provide more accurate and nuanced evaluations of perceived voice quality. These advanced MOS calculations may potentially offer valuable insights for network operators and device manufacturers, helping to optimize voice communication systems for the best possible user experience across a wide range of scenarios.

In some examples, the remedial action may comprise adjusting transmission power of the base station. This adjustment of transmission power may be a tool in optimizing network performance and voice quality, particularly in scenarios where voice quality issues are detected through testing procedures. The process of adjusting base station transmission power may be implemented in various ways, depending on specific network architecture, regulatory constraints, and optimization goals. In some embodiments, the power adjustment might be a gradual process, where the transmission power is incrementally increased or decreased based on continuous voice quality assessments. This technique may allow for fine-tuning of the network performance while potentially minimizing interference with neighboring cells. Alternatively, in scenarios where more immediate improvements may be important, the system might implement more substantial power adjustments, potentially followed by a period of stabilization and further fine-tuning. The decision to adjust transmission power, and the magnitude of such adjustments, might be based on a complex interplay of factors. Voice quality metrics, such as Mean Opinion Score (MOS) or specific indicators of audio degradation, may serve as primary triggers for power adjustments. However, the system might also take into account other network parameters such as signal-to-interference-plus-noise ratio (SINR), reference signal received power (RSRP), and cell load. Advanced embodiments might employ machine learning algorithms to predict the optimal transmission power based on historical data and current network conditions. These AI-driven systems may potentially learn from the outcomes of previous power adjustments, continuously refining their decision-making processes to achieve better results over time.

In some scenarios, the power adjustment process might be coordinated across multiple base stations in a given area. This coordinated technique may help maintain a balanced network environment, potentially preventing situations where power increases in one cell lead to increased interference in neighboring cells. Such coordination might involve complex algorithms that model the entire network topology and predict the cascading effects of power adjustments across multiple cells. The implementation of transmission power adjustments might also vary based on the specific frequency bands and technologies in use. For instance, in a 5G network utilizing both sub-6 GHz and mmWave frequencies, the power adjustment strategies might differ significantly between these bands due to their distinct propagation characteristics. Lower frequency bands might require more careful power management due to their greater potential for long-range interference, while higher frequency bands might allow for different power adjustment techniques due to their more limited range. In some embodiments, the system might employ beam forming techniques in conjunction with power adjustments, enabling for more targeted improvements in voice quality for specific users or areas within a cell. This may involve not only adjusting the overall transmission power but also modifying the power distribution across different antenna elements or sectors of the base station. The timing and duration of power adjustments may also vary depending on the specific implementation and network conditions. In some cases, power adjustments might be implemented as short-term measures to address immediate voice quality issues, with the system reverting to baseline power levels after a predetermined period or once quality metrics return to acceptable levels. In other scenarios, particularly in areas with persistent voice quality challenges, more long-term or even permanent power adjustments might be implemented. The system might also incorporate adaptive scheduling algorithms that adjust transmission power dynamically based on time-of-day patterns in network usage and voice quality demands. These temporal adjustments may help optimize network performance during peak usage hours while conserving energy during off-peak periods.

In some examples, the remedial action may comprise adjusting antenna tilt of the base station. Antenna tilt adjustment may be a powerful method for optimizing network coverage and potentially improving voice quality in mobile networks. This technique involves changing the vertical angle of the base station's antennas, which may significantly affect the distribution of the signal within the cell area. Antenna tilt may be implemented in two primary ways: mechanical tilt and electrical tilt. Mechanical tilt involves physically adjusting the angle of the entire antenna assembly, while electrical tilt uses phase shifting techniques to alter the radiation pattern without moving the physical antenna. In many modern networks, a combination of both mechanical and electrical tilt may be employed to achieve optimal coverage. The decision to adjust antenna tilt, and the specific adjustments made, might be based on a variety of factors including voice quality metrics, network performance data, and geographical considerations. For instance, in urban environments with tall buildings, a steeper downward tilt might be employed to reduce interference between cells and focus the signal on street-level users. Conversely, in rural areas with sparser population density, a shallower tilt might be used to extend coverage over a larger area.

The process of adjusting antenna tilt may be implemented with varying degrees of automation and sophistication. In some basic embodiments, tilt adjustments might be made manually by technicians based on periodic network performance reports and voice quality assessments. More advanced systems might employ remote electrical tilt (RET) technology, enabling real-time adjustments to be made from a centralized network operations center. These RET systems may enable dynamic tilt optimization, where the antenna tilt is continuously adjusted based on changing network conditions and user demands. Some cutting-edge embodiments might utilize artificial intelligence and machine learning algorithms to predict optimal tilt angles based on historical data, current network conditions, and even factors like weather patterns or special events that might affect user distribution within the cell. These AI-driven systems may potentially learn from the outcomes of previous tilt adjustments, continuously refining their decision-making processes to achieve better results over time. In multi-band or multi-technology deployments, antenna tilt adjustments might need to be coordinated across different frequency bands or network generations to ensure optimal performance for all services.

The impact of antenna tilt adjustments on voice quality may be multifaceted. By optimizing the distribution of the signal within the cell, tilt adjustments may potentially improve signal strength and quality for users in areas that were previously underserved. This may lead to better codec rate selection, reduced packet loss, and ultimately improved voice quality. However, tilt adjustments may also affect the coverage area of neighboring cells, potentially creating complex interactions that need to be managed. To address this, some embodiments might employ coordinated tilt optimization across multiple cells in a given area. This may involve sophisticated algorithms that model the entire network topology and predict the cascading effects of tilt adjustments across multiple cells. Such coordination might be particularly important in dense urban environments or in areas with challenging topography where cell boundaries may be complex and overlapping. In some scenarios, antenna tilt adjustments might be combined with other optimization techniques such as power adjustments or beam forming to achieve more comprehensive improvements in network performance and voice quality.

The timing and frequency of antenna tilt adjustments may vary depending on the specific implementation and network conditions. In some cases, tilt might be adjusted as a reactive measure in response to detected voice quality issues or changes in network performance metrics. In other embodiments, proactive tilt optimization might be employed, with regular adjustments made based on predicted changes in user distribution or network load. For example, in areas with significant differences in day and night population distribution (such as business districts), the system might implement scheduled tilt adjustments to optimize coverage for different times of day. Some advanced systems might even incorporate real-time or near-real-time tilt adjustments, continuously optimizing the network based on current conditions and immediate feedback from voice quality assessments.

In some examples, the method may further comprise adjusting an algorithm used to calculate the quality score based on the detected codec rate change. This adjustment of the quality score calculation algorithm may be a dynamic and adaptive process that aims to maintain the accuracy and relevance of voice quality assessments in the face of changing codec rates. The quality score, which may often be represented as a Mean Opinion Score (MOS) or a similar metric, typically seeks to quantify the perceived quality of a voice transmission. When codec rates change during a call, the characteristics of the voice signal may change significantly, potentially affecting how quality should be assessed. By adjusting the calculation algorithm in response to these changes, the system may provide more accurate and contextually appropriate quality scores.

The process of adjusting the quality score calculation algorithm might be implemented in various ways, depending on the specific quality assessment methodology in use and the capabilities of the testing system. In some embodiments, the adjustment might involve switching between different pre-defined algorithms, each optimized for a specific codec rate or range of rates. For example, the system might use one algorithm for high bitrate codecs (e.g., EVS at 24.4 kbps) and another for lower bitrate codecs (e.g., AMR-NB at 4.75 kbps). These different algorithms might place varying weights on different aspects of the voice signal, such as frequency response, packet loss concealment effectiveness, or background noise handling. In more sophisticated systems, the adjustment might be more granular, with continuous modification of algorithm parameters based on the exact codec rate in use. This may involve dynamically adjusting the weights applied to different quality factors, or even modifying the mathematical formulas used to compute the final quality score. Some advanced embodiments might employ machine learning techniques to adapt the quality score calculation in real-time. These AI-driven systems may potentially learn from large datasets of human-rated voice samples across different codec rates, continuously refining their ability to predict perceived quality under various conditions.

The timing and frequency of algorithm adjustments may vary depending on the specific implementation and the nature of the codec rate changes being encountered. In some scenarios, the adjustment might be made immediately upon detection of a codec rate change, potentially resulting in multiple algorithm modifications during a single call if the codec rate fluctuates frequently. Other embodiments might employ a more conservative technique, only adjusting the algorithm when a codec rate change persists for a certain duration, or when the change exceeds a predetermined threshold. This technique may help prevent unnecessary oscillations in the quality assessment process due to transient codec rate changes. Some systems might even implement predictive algorithm adjustment, anticipating codec rate changes based on observed network conditions or historical patterns, and preemptively modifying the quality score calculation to maintain accuracy across the transition.

The scope of the algorithm adjustment might extend beyond merely accounting for the new codec rate. In some embodiments, the adjustment process might also consider factors such as the specific type of codec in use (e.g., narrowband vs. wideband), the network technology (e.g., 4G vs. 5G), or even the type of content being transmitted (e.g., speech vs. music). This holistic technique to algorithm adjustment may potentially provide more nuanced and accurate quality assessments across a wide range of communication scenarios. Additionally, some systems might implement differential algorithm adjustments for different components of the quality score. For example, the adjustment might modify how packet loss is weighted differently at different codec rates, while leaving other aspects of the calculation unchanged. This granular technique to algorithm adjustment may allow for more precise tailoring of the quality assessment to the specific characteristics of each codec rate.

In multi-endpoint testing scenarios, such as conference calls or situations where both ends of a call are being monitored, the algorithm adjustment process might need to account for potentially different codec rates at each endpoint. This may involve implementing separate, coordinated algorithm adjustments for each monitored stream, or developing a unified adjustment technique that may handle asymmetric codec rates. Furthermore, in testing environments that simulate complex network conditions, the algorithm adjustment might need to interact with other aspects of the testing system, such as simulated packet loss generators or network congestion models, to ensure that the quality score remains meaningful and comparable across different test scenarios. By implementing sophisticated and adaptive algorithm adjustment techniques, voice quality testing systems may potentially provide more accurate, relevant, and actionable quality assessments in the face of dynamic codec rate changes and evolving network technologies.

In some examples, the voice quality test may be performed on both originating and terminating ends of a test call. This dual-ended testing technique may provide a more comprehensive assessment of voice quality, capturing the full end-to-end experience of a call. By monitoring both ends of the call, the testing system may be able to identify and distinguish between issues affecting the uplink (from the originating device to the network) and downlink (from the network to the terminating device) portions of the call. This distinction may be particularly valuable in scenarios where network conditions or device capabilities differ significantly between the two ends of the call.

The implementation of dual-ended testing may vary depending on the specific testing setup and objectives. In some cases, it might involve two separate testing devices, one acting as the originator and the other as the terminator, each equipped with its own quality assessment capabilities. Alternatively, a single testing device might simulate both ends of the call, potentially using different virtual instances or separate hardware modules to represent the originating and terminating sides. The synchronization and correlation of data between the two ends may be a important aspect of dual-ended testing. This might involve precise timing mechanisms to align measurements from both ends, or sophisticated data analysis techniques to correlate observed quality issues with specific network events or codec changes. In more advanced embodiments, machine learning algorithms might be employed to identify patterns and relationships between the quality metrics observed at each end of the call, potentially uncovering complex interactions or issues that might not be apparent from single-ended testing alone.

In some examples, a guard time may be implemented after detecting the codec rate change. This guard time may be satisfied when the codec rate remains stable for a predetermined duration, and the affected test segment may be excluded only after the guard time is satisfied. The implementation of a guard time may serve as a stabilization period, enabling the system to confirm that a detected codec rate change is not merely a transient fluctuation before taking action to exclude the affected test segment from the voice quality assessment. This technique may help prevent unnecessary adjustments to the quality assessment process and ensure that only significant and sustained codec rate changes are reflected in the final analysis.

The duration of the guard time may vary depending on the specific implementation and the characteristics of the network being tested. In some scenarios, the guard time might be a fixed duration, such as 500 milliseconds or 1 second. In other embodiments, the guard time may be adaptive, varying based on factors such as the magnitude of the codec rate change, historical patterns of rate stability, or current network conditions. For example, a system might implement a longer guard time for smaller codec rate changes, where the impact on voice quality might be less immediate, and a shorter guard time for more dramatic rate shifts. Some advanced systems might employ machine learning algorithms to dynamically adjust the guard time based on observed patterns of codec rate stability and their impact on voice quality metrics.

The process of monitoring codec rate stability during the guard time may be implemented in various ways. In some cases, the system might continuously sample the codec rate at regular intervals throughout the guard period. Alternatively, it might employ event-driven monitoring, where the codec rate is checked only when certain network events or quality indicators suggest a potential change. The criteria for considering the codec rate “stable” during the guard time may also vary. Some embodiments might require the codec rate to remain exactly constant throughout the entire guard period, while others might allow for minor fluctuations within a predefined tolerance range. In more sophisticated systems, the stability criteria might be based on statistical measures, such as the variance or standard deviation of the codec rate over the guard period.

The handling of voice data during the guard time may be approached in different ways, depending on the specific requirements of the testing system. In some embodiments, the system might continue to process and analyze the voice data during the guard time, but flag it as potentially affected by a codec rate change. This technique enables retroactive exclusion or re-analysis of the data if the guard time is satisfied. Alternatively, the system might temporarily suspend detailed analysis during the guard time, resuming only if the codec rate stabilizes. Some advanced systems might employ parallel processing techniques, simultaneously analyzing the voice data under both the old and new codec rate assumptions during the guard time, and then selecting the appropriate analysis path once stability is confirmed or the guard time expires.

The action taken after the guard time is satisfied may extend beyond simply excluding the affected test segment. In some embodiments, the system might apply more nuanced adjustments to the voice quality assessment process. For example, it might assign reduced weight to the affected segment rather than excluding it entirely, or it might re-analyze the segment using parameters optimized for the new codec rate. In scenarios where multiple codec rate changes occur in close succession, the system might need to handle overlapping guard times or implement more complex decision-making processes to determine which segments to exclude or how to adjust the analysis. Some systems might also use the guard time as an opportunity to recalibrate or adjust other aspects of the testing process, such as updating noise floor estimates or resetting packet loss counters, to ensure that the subsequent analysis accurately reflects the new network conditions following the codec rate change.

In some examples, the codec rate change may be detected based on a mapping table between a bit rate index and corresponding codec rates. This technique leverages standardized or predefined relationships between numerical indices and specific codec rates, potentially enabling efficient and accurate detection of codec rate changes in voice quality testing scenarios. The mapping table may serve as a reference point for interpreting network signals or device settings that indicate the current codec configuration, translating abstract index values into concrete bit rates that directly impact voice quality.

The structure and content of the mapping table may vary depending on the specific codecs and network technologies in use. In some embodiments, the table might be a simple one-to-one mapping between integer indices and bit rates. For example, an index of 0 might correspond to the lowest supported bit rate (e.g., 6.60 kbps for Adaptive Multi-Rate Wideband codec), while higher indices represent progressively higher bit rates. In more complex scenarios, the mapping table might include additional information such as codec type, audio bandwidth (e.g., narrowband, wideband, super-wideband), or specific codec modes. This expanded table may allow for more nuanced detection of codec changes, potentially distinguishing between different types of adaptations that might impact voice quality in distinct ways. Some advanced systems might employ multiple mapping tables for different network technologies or codec families, selecting the appropriate table based on the current network context or device capabilities.

The process of using the mapping table to detect codec rate changes may be implemented through various mechanisms. In some cases, the system might continuously monitor network signaling messages that contain bit rate index information, such as those found in the Radio Resource Control (RRC) layer for cellular networks. When a new index is observed, it may be quickly translated to a codec rate using the mapping table, enabling rapid detection of changes. Alternatively, the system might periodically query device or network elements for their current bit rate index, performing table lookups at regular intervals to track codec rates over time. In more sophisticated embodiments, the mapping table might be integrated into a larger codec rate detection algorithm that combines index-based detection with other methods, such as analysis of voice packet headers or direct observation of voice encoder settings.

The maintenance and updating of the mapping table may be a notable aspect of this detection method. In some embodiments, the table might be hard-coded into the testing system, relying on standardized mappings that remain consistent across different network deployments. However, this technique may require updates to the testing software when new codecs or bit rates are introduced. More flexible systems might allow for dynamic updating of the mapping table, potentially downloading the latest mappings from a central server or learning new mappings through observation and analysis of network behavior. This adaptability may be particularly valuable in testing environments that span multiple network generations or incorporate experimental codec technologies. Some advanced systems might even employ machine learning techniques to refine and expand the mapping table over time, potentially discovering subtle relationships between bit rate indices and actual codec behaviors that might not be captured in standard specifications.

In some examples, reducing the weight of the test segment may comprise excluding the test segment from being used by the voice quality assessment. This technique to handling test segments affected by codec rate changes may help maintain the accuracy and reliability of voice quality assessments in dynamic network environments. By excluding segments where codec rates have changed, the system may potentially avoid skewed or misleading quality scores that might result from analyzing voice data transmitted under different encoding conditions as if it were uniform.

The process of excluding test segments may be implemented in various ways, depending on the specific voice quality assessment methodology and the granularity of the testing system. In some embodiments, exclusion might involve completely removing the affected segment from all calculations and analyses. This may mean discarding the raw voice data for that segment, or flagging it in a way that causes all subsequent processing steps to ignore it. Alternatively, some systems might retain the data from excluded segments for archival or debugging purposes, but ensure that it does not contribute to the final quality scores or metrics. The granularity of exclusion may also vary. In some cases, the system might exclude entire pre-defined test segments, such as complete sentences or phrases used in the testing process. In more fine-grained techniques, the exclusion might be applied at the level of individual frames or packets, enabling partial exclusion of segments that span a codec rate change.

The timing and scope of segment exclusion may be approached in different ways. Some systems might implement immediate exclusion upon detection of a codec rate change, potentially using predictive algorithms to exclude segments proactively if a change appears imminent. Others might employ a retrospective technique, analyzing segments after the fact and excluding those where changes occurred. In scenarios with frequent codec rate changes, the system might need to balance the desire for accurate assessment with the need to retain sufficient data for meaningful analysis. This may involve implementing thresholds for the maximum amount of data that may be excluded, or developing adaptive algorithms that adjust the exclusion criteria based on the overall stability of the codec rate during the test.

The handling of excluded segments in the context of the overall voice quality assessment may present various challenges and opportunities for optimization. For instance, the system might need to adjust its statistical calculations to account for the reduced dataset resulting from exclusions. This may involve normalizing quality scores based on the amount of valid data remaining, or employing more sophisticated statistical techniques that may handle datasets with gaps or irregularities. In some embodiments, the system might attempt to interpolate or estimate quality metrics for excluded segments based on adjacent valid data, potentially providing a more continuous view of voice quality over time. Advanced systems might even employ machine learning techniques to predict the likely quality characteristics of excluded segments, using patterns observed in valid data and knowledge of the codec rate changes that occurred.

The impact of segment exclusion on different types of voice quality metrics might vary. For example, metrics that rely on comparing the received audio to a known reference signal might be more significantly affected by exclusions than metrics based solely on characteristics of the received signal. To address this, some systems might employ different exclusion strategies or adjustment techniques for different types of metrics. Additionally, in testing scenarios that involve analysis of conversational dynamics or interactive voice quality, the exclusion of segments might require careful consideration of how to maintain the temporal relationships and context of the remaining data. Some embodiments might include mechanisms to annotate or flag the locations of excluded segments in the final analysis results, providing testers with clear indications of where codec rate changes impacted the assessment process.

In some examples, reducing the weight of the test segment may comprise applying a reduced weighting factor to the test segment within the voice quality assessment, rather than fully excluding it. This technique enables a more nuanced handling of segments affected by codec rate changes, potentially retaining valuable information while mitigating the impact of sudden encoding shifts on the overall quality assessment. By adjusting the weight of affected segments, the system may reflect the reduced reliability or comparability of these portions of the test while still incorporating their data into the final analysis to some degree.

The implementation of weight reduction for affected test segments may vary in sophistication and granularity. In some basic embodiments, a fixed reduction factor might be applied to all segments where codec rate changes are detected. For instance, the system might reduce the weight of such segments to 50% of their original value in the overall quality calculations. More advanced systems might employ dynamic weighting schemes that adjust the reduction based on factors such as the magnitude of the codec rate change, the duration of the affected segment, or the overall stability of the codec rate throughout the test. This may involve complex algorithms that consider multiple parameters to determine an appropriate weighting factor for each affected segment.

The granularity of weight reduction may also vary significantly between embodiments. Some systems might apply weight adjustments at the level of predefined test segments, such as entire sentences or phrases used in the testing process. Others might implement more fine-grained techniques, adjusting weights for individual frames or packets within a segment. This high-resolution technique may allow for precise handling of scenarios where codec rate changes occur mid-segment, potentially applying graduated weight reductions that reflect the changing reliability of the data within a single test unit.

The integration of weight reduction into the overall voice quality assessment process may require adjustments to various calculation and analysis methods. For metrics that involve averaging or aggregation of quality scores across multiple segments, the system might need to implement weighted averaging techniques that account for the reduced contribution of certain segments. In more complex analysis scenarios, such as those involving machine learning models for quality prediction, the weight reduction might be incorporated as an additional input feature or uncertainty factor in the model. Some advanced systems might even employ adaptive weighting schemes that evolve over the course of a test, learning from observed patterns to optimize the balance between inclusion of all available data and mitigation of codec change impacts.

The use of weight reduction rather than full exclusion may offer several potential advantages in voice quality testing. It enables retention of potentially valuable data from periods of codec rate transition, which might provide insights into the performance of rate adaptation mechanisms or the impact of rate changes on perceived quality. Additionally, this technique may help maintain a more continuous dataset for analysis, avoiding the gaps or discontinuities that might result from full segment exclusion. However, implementing weight reduction effectively may also present challenges, such as determining appropriate reduction factors that meaningfully reflect the impact of codec changes without unduly skewing the overall assessment. To address this, some embodiments might include calibration processes that analyze historical data or conduct controlled tests to optimize weight reduction parameters for different testing scenarios and codec types.

In some examples, the testing UE may be connected to an interface device that simulates audio input and output, and the interface device may be connected to a laptop or computing device running a testing tool that controls test call setup and voice quality assessment.

This configuration represents a sophisticated setup for conducting voice quality tests in mobile network environments, enabling precise control over test parameters and comprehensive data collection. The interface device serves as an intermediary between the testing UE and the analysis equipment, enabling the simulation of real-world audio conditions while facilitating detailed monitoring and control of the testing process.

The interface device in this setup may take various forms, depending on the specific testing requirements and the technologies being evaluated. In some embodiments, it might be a specialized hardware unit designed specifically for voice quality testing. These devices typically feature multiple ports for connecting to one or more testing UEs, as well as a connection to the laptop running the testing software. The interface device may incorporate sophisticated audio processing capabilities, including high-quality analog-to-digital and digital-to-analog converters, to ensure accurate reproduction and capture of audio signals. Some advanced interface devices might also include features for simulating various network conditions or impairments, enabling testers to evaluate voice quality under a range of scenarios without relying solely on live network conditions.

The simulation of audio input and output by the interface device is a notable aspect of this testing setup. In many embodiments, this simulation may involve the playback of standardized test sentences, such as Harvard sentences, which are designed to provide a consistent and phonetically balanced basis for voice quality assessment. The interface device might store these test sentences internally or receive them from the testing tool running on the laptop. During a test call, the device would play these sentences through its audio output, simulating a speaker's voice, and then capture the received audio through its input, simulating the listener's experience. This technique enables controlled and repeatable testing, as the same audio samples may be used across multiple tests or testing locations. Some advanced interface devices might offer capabilities for dynamically generating or modifying test audio, potentially enabling more varied or realistic testing scenarios.

The connection between the interface device and the laptop running the testing tool enables sophisticated control and analysis of the voice quality tests. This connection, often implemented via USB or a similar high-speed interface, enables the testing tool to configure test parameters, initiate and terminate test calls, and receive real-time data from the interface device. The testing tool itself may be a complex software package capable of managing various aspects of the testing process. It might include features for scheduling tests, configuring codec settings, analyzing received audio in real-time, and generating detailed reports on voice quality metrics. Some testing tools might incorporate advanced signal processing algorithms or machine learning models to perform sophisticated analysis of voice quality, potentially detecting subtle impairments or quality variations that might not be immediately apparent to human listeners.

In more advanced testing setups, the interface device might support simultaneous connection to multiple testing UEs, enabling the simulation of multi-party calls or the concurrent testing of different device models or network configurations. This capability may be particularly valuable for evaluating voice quality in conference call scenarios or for comparing the performance of different devices under identical network conditions. The testing tool running on the laptop might then need to manage multiple simultaneous data streams, potentially correlating quality metrics across different devices or call legs to provide a comprehensive view of voice quality in complex communication scenarios.

The flexibility of this testing setup enables a wide range of voice quality assessment methodologies to be implemented. For instance, the system may be used to perform single-ended testing, where only the received audio is analyzed, or double-ended testing, where both the transmitted and received audio are compared to assess quality degradation. The testing tool might implement various industry-standard quality assessment algorithms, such as POLQA or PESQ, as well as custom metrics developed for specific testing needs. Additionally, this setup may facilitate adaptive testing techniques, where the test sequences or analysis methods are dynamically adjusted based on detected network conditions or codec changes. For example, if the testing tool detects a codec rate change through analysis of network signaling or audio characteristics, it might instruct the interface device to switch to a different set of test sentences or adjust its audio processing parameters to maintain the validity of the quality assessment.

In some examples, the voice quality test may be performed during a drive test to assess network performance across different geographic locations. Drive testing is a method of assessing mobile network performance by conducting tests while traveling through various areas within a network's coverage. This technique enables the evaluation of network quality and performance under real-world conditions, taking into account factors such as terrain, building density, and movement between different cell sites. By conducting voice quality tests during drive tests, network operators and equipment manufacturers may gain valuable insights into how their networks perform across diverse environments and identify areas where improvements may be needed.

The implementation of drive testing for voice quality assessment may vary in complexity and scope. In its simplest form, drive testing might involve a single vehicle equipped with testing devices traveling along a predetermined route while conducting periodic voice quality tests. More sophisticated setups might employ multiple vehicles operating simultaneously in different areas, or even use public transportation or pedestrian testers to cover areas not easily accessible by car. The testing equipment used in drive tests typically includes specialized mobile devices or testing UEs, GPS receivers for precise location tracking, and laptops or other computing devices running testing and analysis software. In some cases, the testing setup might also include external antennas or other equipment to enhance signal reception or simulate different usage scenarios.

The routes chosen for drive testing may significantly impact the insights gained from the process. Some drive tests might focus on major highways and urban centers to assess performance in high-traffic areas, while others might specifically target known problem areas or locations with challenging network conditions. In many cases, drive test routes are designed to cover a representative sample of the network's coverage area, including a mix of urban, suburban, and rural environments. The frequency and duration of voice quality tests conducted during a drive test may also vary. Some embodiments might perform continuous testing throughout the drive, while others might conduct tests at regular intervals or at specific predefined locations.

Data collection during drive tests for voice quality assessment often goes beyond just the voice quality metrics themselves. The testing system might also record detailed information about network conditions, including signal strength, interference levels, and handover events between cell sites. GPS data is typically used to precisely map test results to specific geographic locations, enabling the creation of coverage maps and the identification of localized issues. Some advanced drive testing setups might also incorporate video recording of the route or even 360-degree cameras to provide visual context for the collected data, which may be valuable for understanding the physical environment's impact on network performance.

The analysis of drive test data for voice quality assessment often involves complex post-processing and visualization techniques. Raw data collected during the drive test might be combined with network topology information, terrain data, and other contextual information to provide a comprehensive view of network performance. Advanced analysis tools might employ machine learning algorithms to identify patterns or anomalies in the data, potentially uncovering subtle issues that might not be apparent from individual test results. The results of drive test analysis may be presented in the form of detailed maps showing voice quality scores overlaid on geographic data, enabling network operators to quickly identify problem areas or trends in performance across different regions.

In scenarios where codec rate adaptation is a focus of the testing, drive tests may provide valuable insights into how these adaptations perform under varying real-world conditions. As the testing vehicle moves through areas with different levels of network coverage and quality, the system may observe how codec rates change and how these changes impact voice quality. This dynamic testing environment may help validate the effectiveness of codec rate adaptation algorithms and identify scenarios where they might not perform as expected. For example, the testing might reveal areas where frequent codec rate changes due to rapidly changing network conditions lead to perceptible fluctuations in voice quality, or identify locations where the network fails to adapt the codec rate appropriately to maintain acceptable voice quality.

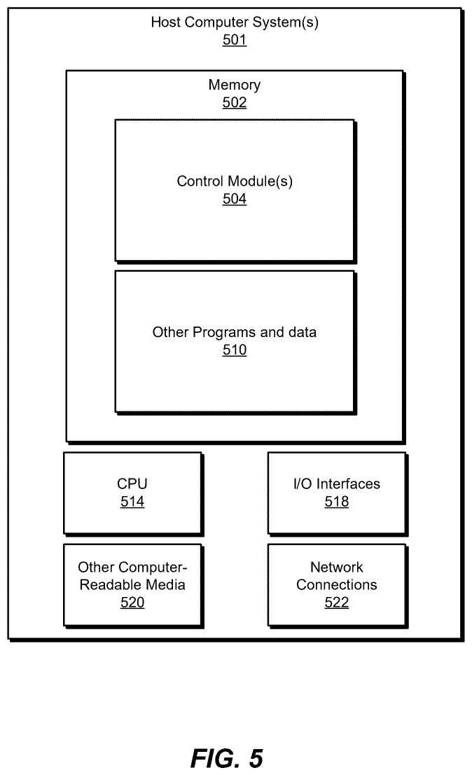

FIG. 5 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 5 illustrates an example of underlying hardware on which such software and functionality may be hosted and/or implemented.

In particular, shown is example host computer system(s) 501. For example, such computer system(s) 501 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 501 may include memory 502, one or more central processing units (CPUs) 514, I/O interfaces 518, other computer-readable media 520, and network connections 522.

Memory 502 may include one or more various types of non-volatile and/or volatile storage technologies. Examples of memory 502 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 502 may be utilized to store information, including computer-readable instructions that are utilized by CPU 514 to perform actions, including those of embodiments described herein.

Memory 502 may have stored thereon control module(s) 504. The control module(s) 504 may be configured to implement and/or perform some or all of the functions of the systems or components described herein. Memory 502 may also store other programs and data 510, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 522 are configured to communicate with other computing devices to facilitate the functionality described herein. In various embodiments, the network connections 522 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 518 may include a video interface, other data input or output interfaces, or the like. Other computer-readable media 520 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
detecting a codec rate change during a voice quality test of a testing UE that emulates a subscriber UE connecting to a base station in a mobile network such that a test segment during which the codec rate change occurred is identified;
reducing, based on detecting that the codec rate change occurred during the test segment, a weight of the test segment within a voice quality assessment; and
performing, in response to the voice quality assessment indicating that a quality score is below a threshold, a remedial action such that voice quality for subscriber UEs connecting to the base station is improved.

2. The method of claim 1, wherein each test segment in a set of test segments used for the voice quality assessment comprises a sentence.

3. The method of claim 2, wherein each sentence comprises a Harvard sentence.

4. The method of claim 1, wherein detecting the codec rate change comprises analyzing Real-time Transport Protocol (RTP) payload information.

5. The method of claim 1, wherein detecting the codec rate change comprises detecting changes in a bit rate index in Medium Access Control (MAC) layer messages.

6. The method of claim 1, wherein detecting the codec rate change comprises monitoring vocoder settings of the testing UE.

7. The method of claim 1, wherein the voice quality assessment comprises calculating a Mean Opinion Score (MOS).

8. The method of claim 1, wherein the remedial action comprises adjusting transmission power of the base station.

9. The method of claim 1, wherein the remedial action comprises adjusting antenna tilt of the base station.

10. The method of claim 1, further comprising adjusting an algorithm used to calculate the quality score based on the detected codec rate change.

11. The method of claim 1, wherein the voice quality test is performed on both originating and terminating ends of a test call.

12. The method of claim 1, wherein:
a guard time is implemented after detecting the codec rate change;
the guard time is satisfied when the codec rate remains stable for a predetermined duration; and
the test segment is excluded only after the guard time is satisfied.

13. The method of claim 1, wherein the codec rate change is detected based on a mapping table between a bit rate index and corresponding codec rates.

14. The method of claim 1, wherein reducing the weight of the test segment comprises excluding the test segment from being used by the voice quality assessment.

15. The method of claim 1, wherein:
the testing UE is connected to an interface device that simulates audio input and output; and
the interface device is connected to a laptop running a testing tool that controls test call setup and voice quality assessment.

16. The method of claim 1, wherein the voice quality test is performed during a drive test to assess network performance across different geographic locations.

17. A non-transitory computer-readable medium that has instructions stored thereon that, when executed by at least one physical computing processor, cause a computing device to perform operations comprising:
detecting a codec rate change during a voice quality test of a testing UE that emulates a subscriber UE connecting to a base station in a mobile network such that a test segment during which the codec rate change occurred is identified;
reducing, based on detecting that the codec rate change occurred during the test segment, a weight of the test segment within a voice quality assessment; and
performing, in response to the voice quality assessment indicating that a quality score is below a threshold, a remedial action such that voice quality for subscriber UEs connecting to the base station is improved.

18. The non-transitory computer-readable medium of claim 17, wherein each test segment in a set of test segments used for the voice quality assessment comprises a sentence.

19. A system comprising:
at least one physical computing processor of a computing device; and
a non-transitory computer-readable medium that has instructions stored thereon that, when executed by the at least one physical computing processor, cause the computing device to perform operations comprising:
detecting a codec rate change during a voice quality test of a testing UE that emulates a subscriber UE connecting to a base station in a mobile network such that a test segment during which the codec rate change occurred is identified;
reducing, based on detecting that the codec rate change occurred during the test segment, a weight of the test segment within a voice quality assessment; and
performing, in response to the voice quality assessment indicating that a quality score is below a threshold, a remedial action such that voice quality for subscriber UEs connecting to the base station is improved.

20. The system of claim 19, wherein each test segment in a set of test segments used for the voice quality assessment comprises a sentence.
